(19) United States
(12) Patent Application Publication
(10) Pub. No.: US 2007/0033385 A1
(43) Pub. Date: Feb. 8, 2007

(54) Call return stack way prediction repair

(75) Inventors: Gregory William Smaus, Austin, TX (US); Michael Tuuk, Round Rock, TX (US); Raghuram S. Tupuri, Austin, TX (US)

Correspondence Address: MEYERTONS, HOOD, KIVLIN, KOWERT & GOETZEL (AMD), P.O. BOX 398, AUSTIN, TX, 78767-0398, US

(73) Assignee: Advanced Micro Devices, Inc.

(21) Appl. No.: 11/195,186

(22) Filed: Aug. 2, 2005

(51) Int. Cl. G06F 9/44

(52) U.S. Cl. 712/242

(57) ABSTRACT

A mechanism for repairing way mispredictions in a cache. An instruction cache in a processor is coupled to receive a fetch address and a corresponding way prediction. A return address stack is configured to store a return address corresponding to a fetched branch instruction, a return address way prediction, and information identifying the branch instruction. In response to detecting the return address way prediction is incorrect, the information identifying the branch instruction which is popped from the return address stack is utilized to identify the corresponding branch instruction and repair the return address way prediction. If way misprediction is detected by the instruction cache, the instruction cache is configured to search additional ways for a hit. In the event of a hit in the additional ways, the instruction cache is configured to convey an updated way prediction. In the event of a miss, the instruction cache is configured to convey a miss indication.

### BACKGROUND OF THE INVENTION

1. Field of the Invention

This invention is related to the field of processors and, more particularly, to caching mechanisms within processors.

2. Description of the Related Art

Superscalar processors achieve high performance by simultaneously executing multiple instructions in a clock cycle and by specifying the shortest possible clock cycle consistent with the design. As used herein, the term “clock cycle” refers to an interval of time during which the pipeline stages of a processor perform their intended functions. At the end of a clock cycle, the resulting values are moved to the next pipeline stage. Clocked storage devices (e.g. registers, latches, flops, etc.) may capture their values in response to a clock signal defining the clock cycle.

To reduce effective memory latency, processors typically include caches. Caches are high speed memories used to store previously fetched instruction and/or data bytes. The cache memories may be capable of providing substantially lower memory latency than the main memory employed within a computer system including the processor.

Caches may be organized into a “set associative” structure. In a set associative structure, the cache is organized as a two-dimensional array having rows (often referred to as “sets”) and columns (often referred to as “ways”). When a cache is searched for bytes residing at an address, a number of bits from the address are used as an “index” into the cache. The index selects a particular set within the two-dimensional array, and therefore the number of address bits required for the index is determined by the number of sets configured into the cache. The act of selecting a set via an index is referred to as “indexing”. Each way of the cache has one cache line storage location which is a member of the selected set (where a cache line is a number of contiguous bytes treated as a unit for storage in the cache, and may typically be in the range of 16-64 bytes, although any number of bytes may be defined to compose a cache line). The addresses associated with bytes stored in the ways of the selected set are examined to determine if any of the addresses stored in the set match the requested address. If a match is found, the access is said to be a “hit”, and the cache provides the associated bytes. If a match is not found, the access is said to be a “miss”. When a miss is detected, the bytes are transferred from the main memory system into the cache. The addresses associated with bytes stored in the cache are also stored. These stored addresses are referred to as “tags” or “tag addresses”.

As mentioned above, a cache line storage location from each way of the cache is a member of the selected set (i.e. is accessed in response to selecting the set). Information stored in one of the ways is provided as the output of the cache, and that way is selected by providing a way selection to the cache. The way selection identifies the way to be selected as an output. In a typical set associative cache, the way selection is determined by examining the tags within a set and finding a match between one of the tags and the requested address.

Unfortunately, set associative caches may be higher latency than a direct mapped cache (which provides one cache line storage location per index) due to the tag comparison to determine the way selection for the output. Furthermore, since the way selection is not know prior to the access, each way is typically accessed and the corresponding way selection is used to late select the output bytes if a hit is detected. Accessing all of the ways may cause undesirably high power consumption. Limiting power consumption is rapidly achieving equal par with increasing operating speed (or frequency) in modern processors. Accordingly, a low latency, low power consuming method for accessing a set associative cache is desired.

In view of the problems, methods have been developed to predict a particular way at the time of access. In such an approach, the cache is coupled to receive an input address and a corresponding way prediction. The cache then provides output bytes in response to the predicted way (instead of performing tag comparisons to select the output bytes). In this manner, access latency may be reduced as compared to performing the tag comparisons. As may be appreciated, the predicted way may not always be correct. Therefore, various approaches to correcting, or repairing, such mis-predictions may be used. Typically, a way prediction repair mechanism may operate as follows:
1. A cache fetch is executed to a line A, which provides predicted way information for the next fetch (e.g., line B). Assume, in this example, the prediction indicates line B is in way n.
2. Tags are then read from all ways in the cache and compared to the tag of the actual fetch.
3. If the tag in the predicted way n does not match the line B fetch address, but another way matches, a way mispredict is signaled.
4. The way repair logic is then informed of the actual way which contains line B. The repair logic then writes this updated way information into line A so that the next time the way prediction information is read from line A, it will match where line B is actually stored.

The above approach to way mispredict repair is well suited for sequential fetches wherein one fetch immediately follows the next. In such a case, the address of the previous fetch (the one which provided the prediction, such as line A in the example above) is still “live” in the machine. Consequently, the information which is being repaired is still live in the machine and readily accessible.

While the above approach may be well suited for the generally sequential case, it is less well suited for the cases which are not generally sequential. For example, the case of CALL-RETURN pairs presents a unique problem in that the cache line with the CALL instruction contains the way prediction for the RETURN instruction which will execute in the future. However, unlike in the generally sequential case, the RETURN instruction may execute hundreds, or thousands, of instructions later. If the RETURN way prediction turns out to be incorrect, the address of the cache line with the CALL instruction, and the corresponding way prediction information for the RETURN instruction, has long since been lost by the processor.

Accordingly, an effective way prediction repair method and mechanism is desired.

### SUMMARY

A method and mechanism for repairing way mispredictions in a cache are contemplated.

A processor includes a prediction logic unit, an instruction cache, and a return address stack. The prediction logic unit is configured to convey a way prediction corresponding to a received fetch address, and the instruction cache is coupled to receive both the fetch address and the way prediction. If a way misprediction is detected by the instruction cache, the instruction cache is configured to search additional ways for a hit. In the event of a hit in the additional ways, the instruction cache is configured to convey an updated way prediction. In the event of a miss, the instruction cache is configured to convey a miss indication.

A return address stack in the processor is configured to store a return address corresponding to a fetched branch instruction. In addition to storing the return address, the return address stack is further configured to store a return address way prediction associated with the branch instruction. The return address stack is also configured to store information identifying the branch instruction. In response to detecting the return address way prediction is incorrect, the information identifying the branch instruction which is popped from the return address stack is utilized to identify the corresponding branch instruction and repair the return address way prediction.

### BRIEF DESCRIPTION OF THE DRAWINGS

Other objects and advantages of the invention will become apparent upon reading the following detailed description and upon reference to the accompanying drawings in which:

FIG. 1 is a block diagram of one embodiment of a processor.

FIG. 2 illustrates one embodiment of a branch prediction mechanism.

FIG. 3 illustrates a portion of the mechanism of FIG. 2.

FIG. 4 depicts one embodiment of a method for performing way misprediction repair.

FIG. 5 is a block diagram of one embodiment of a computer system including the processor shown in FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Processor Overview

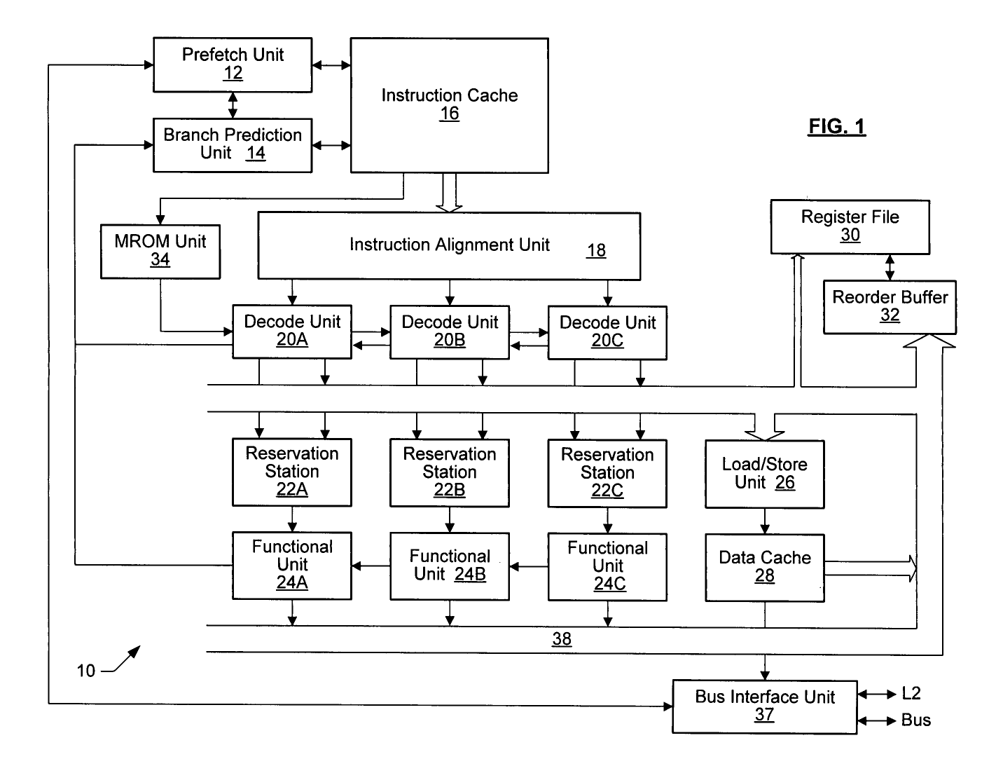

Turning now to FIG. 1, a block diagram of one embodiment of a processor 10 is shown. Other embodiments are possible and contemplated. As shown in FIG. 1, processor 10 includes a prefetch unit 12, a branch prediction unit 14, an instruction cache 16, an instruction alignment unit 18, a plurality of decode units 20A-20C, a plurality of reservation stations 22A-22C, a plurality of functional units 24A-24C, a load/store unit 26, a data cache 28, a register file 30, a reorder buffer 32, an MROM unit 34, and a bus interface unit 37. Elements referred to herein with a particular reference number followed by a letter will be collectively referred to by the reference number alone. For example, decode units 20A-20C will be collectively referred to as decode units 20.

Prefetch unit 12 is coupled to receive instructions from bus interface unit 37, and is further coupled to instruction cache 16 and branch prediction unit 14. Similarly, branch prediction unit 14 is coupled to instruction cache 16. Still further, branch prediction unit 14 is coupled to decode units 20 and functional units 24. Instruction cache 16 is further coupled to MROM unit 34 and instruction alignment unit 18. Instruction alignment unit 18 is in turn coupled to decode units 20. Each decode unit 20A-20C is coupled to load/store unit 26 and to respective reservation stations 22A-22C. Reservation stations 22A-22C are further coupled to respective functional units 24A-24C. Additionally, decode units 20 and reservation stations 22 are coupled to register file 30 and reorder buffer 32. Functional units 24 are coupled to load/store unit 26, register file 30, and reorder buffer 32 as well. Data cache 28 is coupled to load/store unit 26 and to bus interface unit 37. Bus interface unit 37 is further coupled to an L2 interface to an L2 cache and a bus. Finally, MROM unit 34 is coupled to decode units 20.

Instruction cache 16 is a high speed cache memory provided to store instructions. Instructions are fetched from instruction cache 16 and dispatched to decode units 20. In one embodiment, instruction cache 16 is configured to store up to 64 kilobytes of instructions in a 2 way set associative structure having 64 byte lines (a byte comprises 8 binary bits). Alternatively, any other desired configuration and size may be employed. For example, it is noted that instruction cache 16 may be implemented as a fully associative, set associative, or direct mapped configuration.

Instructions are stored into instruction cache 16 by prefetch unit 12. Instructions may be prefetched prior to the request thereof from instruction cache 16 in accordance with a prefetch scheme. A variety of prefetch schemes may be employed by prefetch unit 12. Instructions fetched from the instruction cache are passed to the scanner/aligner. When instructions are fetched for the first time, they are not marked by predecode tags. In this case, the scanner/aligner passes 4 bytes per clock to the decode unit 20. As decode unit 20 dispatches unpredecoded instructions to the core, the decode unit may generate predecode data corresponding to the instructions which indicates the instruction boundaries.

One encoding of the predecode tags for an embodiment of processor 10 employing a variable byte length instruction set will next be described. A variable byte length instruction set is an instruction set in which different instructions may occupy differing numbers of bytes. An exemplary variable byte length instruction set employed by one embodiment of processor 10 is the ×86 instruction set.

In the exemplary encoding, if a given byte is the last byte of an instruction, the end bit for that byte is set. Instructions which may be directly decoded by decode units 20 are referred to as “fast path” instructions. The remaining x86 instructions are referred to as MROM instructions, according to one embodiment. For example, a fast path instruction including two prefix bytes, a Mod R/M byte, and an immediate byte would have end bits as follows:
End bits 00001

MROM instructions are instructions which are determined to be too complex for decode by decode units 20. MROM instructions are executed by invoking MROM unit 34. More specifically, when an MROM instruction is encountered, MROM unit 34 parses and issues the instruction into a subset of defined fast path instructions to effectuate the desired operation. MROM unit 34 dispatches the subset of fast path instructions to decode units 20.

Processor 10 employs branch prediction in order to speculatively fetch instructions subsequent to conditional branch instructions. Branch prediction unit 14 is included to perform branch prediction operations. In one embodiment, branch prediction unit 14 employs a branch target buffer which caches up to three branch target addresses and corresponding taken/not taken predictions per 16 byte portion of a cache line in instruction cache 16. The branch target buffer may, for example, comprise 2048 entries or any other suitable number of entries. Prefetch unit 12 determines initial branch targets when a particular line is predecoded. Subsequent updates to the branch targets corresponding to a cache line may occur due to the execution of instructions within the cache line. Instruction cache 16 provides an indication of the instruction address being fetched, so that branch prediction unit 14 may determine which branch target addresses to select for forming a branch prediction. Decode units 20 and functional units 24 provide update information to branch prediction unit 14. Decode units 20 detect branch instructions which were not predicted by branch prediction unit 14. Functional units 24 execute the branch instructions and determine if the predicted branch direction is incorrect. The branch direction may be “taken”, in which subsequent instructions are fetched from the target address of the branch instruction. Conversely, the branch direction may be “not taken”, in which subsequent instructions are fetched from memory locations consecutive to the branch instruction. When a mispredicted branch instruction is detected, instructions subsequent to the mispredicted branch are discarded from the various units of processor 10. In an alternative configuration, branch prediction unit 14 may be coupled to reorder buffer 32 instead of decode units 20 and functional units 24, and may receive branch misprediction information from reorder buffer 32. A variety of suitable branch prediction algorithms may be employed by branch prediction unit 14.

Instructions fetched from instruction cache 16 are conveyed to instruction alignment unit 18. As instructions are fetched from instruction cache 16, the corresponding predecode data is scanned to provide information to instruction alignment unit 18 (and to MROM unit 34) regarding the instructions being fetched. Instruction alignment unit 18 scans the predecode data to align an instruction to each of decode units 20. In one embodiment, instruction alignment unit 18 aligns instructions from two sets of sixteen instruction bytes to decode units 20. Decode unit 20A receives an instruction which is prior to instructions concurrently received by decode units 20B and 20C (in program order). Similarly, decode unit 20B receives an instruction which is prior to the instruction concurrently received by decode unit 20C in program order.

Decode units 20 are configured to decode instructions received from instruction alignment unit 18. Register operand information is detected and routed to register file 30 and reorder buffer 32. Additionally, if the instructions require one or more memory operations to be performed, decode units 20 dispatch the memory operations to load/store unit 26. Each instruction is decoded into a set of control values for functional units 24, and these control values are dispatched to reservation stations 22 along with operand address information and displacement or immediate data which may be included with the instruction. In one particular embodiment, each instruction is decoded into up to two operations which may be separately executed by functional units 24A-24C.

Processor 10 supports out of order execution, and thus employs reorder buffer 32 to keep track of the original program sequence for register read and write operations, to implement register renaming, to allow for speculative instruction execution and branch misprediction recovery, and to facilitate precise exceptions. A temporary storage location within reorder buffer 32 is reserved upon decode of an instruction that involves the update of a register to thereby store speculative register states. If a branch prediction is incorrect, the results of speculatively-executed instructions along the mispredicted path can be invalidated in the buffer before they are written to register file 30. Similarly, if a particular instruction causes an exception, instructions subsequent to the particular instruction may be discarded. In this manner, exceptions are “precise” (i.e. instructions subsequent to the particular instruction causing the exception are not completed prior to the exception). It is noted that a particular instruction is speculatively executed if it is executed prior to instructions which precede the particular instruction in program order. Preceding instructions may be a branch instruction or an exception-causing instruction, in which case the speculative results may be discarded by reorder buffer 32.

The instruction control values and immediate or displacement data provided at the outputs of decode units 20 are routed directly to respective reservation stations 22. In one embodiment, each reservation station 22 is capable of holding instruction information (i.e., instruction control values as well as operand values, operand tags and/or immediate data) for up to five pending instructions awaiting issue to the corresponding functional unit. It is noted that for the embodiment of FIG. 1, each reservation station 22 is associated with a dedicated functional unit 24. Accordingly, three dedicated “issue positions” are formed by reservation stations 22 and functional units 24. In other words, issue position 0 is formed by reservation station 22A and functional unit 24A. Instructions aligned and dispatched to reservation station 22A are executed by functional unit 24A. Similarly, issue position 1 is formed by reservation station 22B and functional unit 24B; and issue position 2 is formed by reservation station 22C and functional unit 24C.

Upon decode of a particular instruction, if a required operand is a register location, register address information is routed to reorder buffer 32 and register file 30 simultaneously. In one embodiment, reorder buffer 32 includes a future file which receives operand requests from decode units as well. Those of skill in the art will appreciate that the ×86 register file includes eight 32 bit real registers (i.e., typically referred to as EAX, EBX, ECX, EDX, EBP, ESI, EDI and ESP). In embodiments of processor 10 which employ the x86 processor architecture, register file 30 comprises storage locations for each of the 32 bit real registers. Additional storage locations may be included within register file 30 for use by MROM unit 34. Reorder buffer 32 contains temporary storage locations for results which change the contents of these registers to thereby allow out of order execution. A temporary storage location of reorder buffer 32 is reserved for each instruction which, upon decode, is determined to modify the contents of one of the real registers. Therefore, at various points during execution of a particular program, reorder buffer 32 may have one or more locations which contain the speculatively executed contents of a given register. If following decode of a given instruction it is determined that reorder buffer 32 has a previous location or locations assigned to a register used as an operand in the given instruction, the reorder buffer 32 forwards to the corresponding reservation station either: 1) the value in the most recently assigned location, or 2) a tag for the most recently assigned location if the value has not yet been produced by the functional unit that will eventually execute the previous instruction. If reorder buffer 32 has a location reserved for a given register, the operand value (or reorder buffer tag) is provided from reorder buffer 32 rather than from register file 30. If there is no location reserved for a required register in reorder buffer 32, the value is taken directly from register file 30. If the operand corresponds to a memory location, the operand value is provided to the reservation station through load/store unit 26.

In one particular embodiment, reorder buffer 32 is configured to store and manipulate concurrently decoded instructions as a unit. This configuration will be referred to herein as “line-oriented”. By manipulating several instructions together, the hardware employed within reorder buffer 32 may be simplified. For example, a line-oriented reorder buffer included in the present embodiment allocates storage sufficient for instruction information pertaining to three instructions (one from each decode unit 20) whenever one or more instructions are issued by decode units 20. By contrast, a variable amount of storage is allocated in conventional reorder buffers, dependent upon the number of instructions actually dispatched. A comparatively larger number of logic gates may be required to allocate the variable amount of storage. When each of the concurrently decoded instructions has executed, the instruction results are stored into register file 30 simultaneously. The storage is then free for allocation to another set of concurrently decoded instructions. Additionally, the amount of control logic circuitry employed per instruction is reduced because the control logic is amortized over several concurrently decoded instructions. A reorder buffer tag identifying a particular instruction may be divided into two fields: a line tag and an offset tag. The line tag identifies the set of concurrently decoded instructions including the particular instruction, and the offset tag identifies which instruction within the set corresponds to the particular instruction. It is noted that storing instruction results into register file 30 and freeing the corresponding storage is referred to as “retiring” the instructions. It is further noted that any reorder buffer configuration may be employed in various embodiments of processor 10, including using a future file to store the speculative state of register file 30.

As noted earlier, reservation stations 22 store instructions until the instructions are executed by the corresponding functional unit 24. An instruction is selected for execution if: (i) the operands of the instruction have been provided; and (ii) the operands have not yet been provided for instructions which are within the same reservation station 22A-22C and which are prior to the instruction in program order. It is noted that when an instruction is executed by one of the functional units 24, the result of that instruction is passed directly to any reservation stations 22 that are waiting for that result at the same time the result is passed to update reorder buffer 32 (this technique is commonly referred to as “result forwarding”). An instruction may be selected for execution and passed to a functional unit 24A-24C during the clock cycle that the associated result is forwarded. Reservation stations 22 route the forwarded result to the functional unit 24 in this case. In embodiments in which instructions may be decoded into multiple operations to be executed by functional units 24, the operations may be scheduled separately from each other.

In one embodiment, each of the functional units 24 is configured to perform integer arithmetic operations of addition and subtraction, as well as shifts, rotates, logical operations, and branch operations. The operations are performed in response to the control values decoded for a particular instruction by decode units 20. It is noted that a floating point unit (not shown) may also be employed to accommodate floating point operations. The floating point unit may be operated as a coprocessor, receiving instructions from MROM unit 34 or reorder buffer 32 and subsequently communicating with reorder buffer 32 to complete the instructions. Additionally, functional units 24 may be configured to perform address generation for load and store memory operations performed by load/store unit 26. In one particular embodiment, each functional unit 24 may comprise an address generation unit for generating addresses and an execute unit for performing the remaining functions. The two units may operate independently upon different instructions or operations during a clock cycle.

Each of the functional units 24 also provides information regarding the execution of conditional branch instructions to the branch prediction unit 14. If a branch prediction was incorrect, branch prediction unit 14 flushes instructions subsequent to the mispredicted branch that have entered the instruction processing pipeline, and causes fetch of the required instructions from instruction cache 16 or main memory. It is noted that in such situations, results of instructions in the original program sequence which occur after the mispredicted branch instruction are discarded, including those which were speculatively executed and temporarily stored in load/store unit 26 and reorder buffer 32. It is further noted that branch execution results may be provided by functional units 24 to reorder buffer 32, which may indicate branch mispredictions to functional units 24.

Results produced by functional units 24 are sent to reorder buffer 32 if a register value is being updated, and to load/store unit 26 if the contents of a memory location are changed. If the result is to be stored in a register, reorder buffer 32 stores the result in the location reserved for the value of the register when the instruction was decoded. A plurality of result buses 38 are included for forwarding of results from functional units 24 and load/store unit 26. Result buses 38 convey the result generated, as well as the reorder buffer tag identifying the instruction being executed.

Load/store unit 26 provides an interface between functional units 24 and data cache 28. In one embodiment, load/store unit 26 is configured with two load/store buffers. The first load/store buffer includes storage locations for data and address information corresponding to pending loads or stores which have not accessed data cache 28. The second load/store buffer includes storage locations for data and address information corresponding to loads and stores which have accessed data cache 28. For example, the first buffer may comprise 12 locations and the second buffer may comprise 32 locations. Decode units 20 arbitrate for access to the load/store unit 26. When the first buffer is full, a decode unit must wait until load/store unit 26 has room for the pending load or store request information. Load/store unit 26 also performs dependency checking for load memory operations against pending store memory operations to ensure that data coherency is maintained. A memory operation is a transfer of data between processor 10 and the main memory subsystem. Memory operations may be the result of an instruction which utilizes an operand stored in memory, or may be the result of a load/store instruction which causes the data transfer but no other operation. Additionally, load/store unit 26 may include a special register storage for special registers such as the segment registers and other registers related to the address translation mechanism defined by the x86 processor architecture.

Data cache 28 is a high speed cache memory provided to temporarily store data being transferred between load/store unit 26 and the main memory subsystem. In one embodiment, data cache 28 has a capacity of storing up to 64 kilobytes of data in an two way set associative structure. It is understood that data cache 28 may be implemented in a variety of specific memory configurations, including a set associative configuration, a fully associative configuration, a direct-mapped configuration, and any suitable size of any other configuration.

In one particular embodiment of processor 10 employing the x86 processor architecture, instruction cache 16 and data cache 28 are linearly addressed and physically tagged. The linear address is formed from the offset specified by the instruction and the base address specified by the segment portion of the x86 address translation mechanism. Linear addresses may optionally be translated to physical addresses for accessing a main memory. The linear to physical translation is specified by the paging portion of the x86 address translation mechanism. The physical address is compared to the physical tags to determine a hit/miss status.

Bus interface unit 37 is configured to communicate between processor 10 and other components in a computer system via a bus. For example, the bus may be compatible with the EV-6 bus developed by Digital Equipment Corporation. Alternatively, any suitable interconnect structure may be used including packet-based, unidirectional or bi-directional links, etc. An optional L2 cache interface may be employed as well for interfacing to a level two cache.

For the remainder of this description, the x86 microprocessor architecture will be used as an example. However, the branch prediction technique described herein may be employed within any microprocessor architecture, and such embodiments are contemplated. It is noted that, in the x86 microprocessor architecture, there is defined a subroutine return instruction (e.g. the RET instruction) consisting of a single byte opcode. The subroutine return instruction specifies that its branch target address is drawn from the top of the stack indicated by the ESP register. Handling of this single byte RET instruction may present special issues in some circumstances. A mechanism for dealing with this case is illustrated in more detail below.

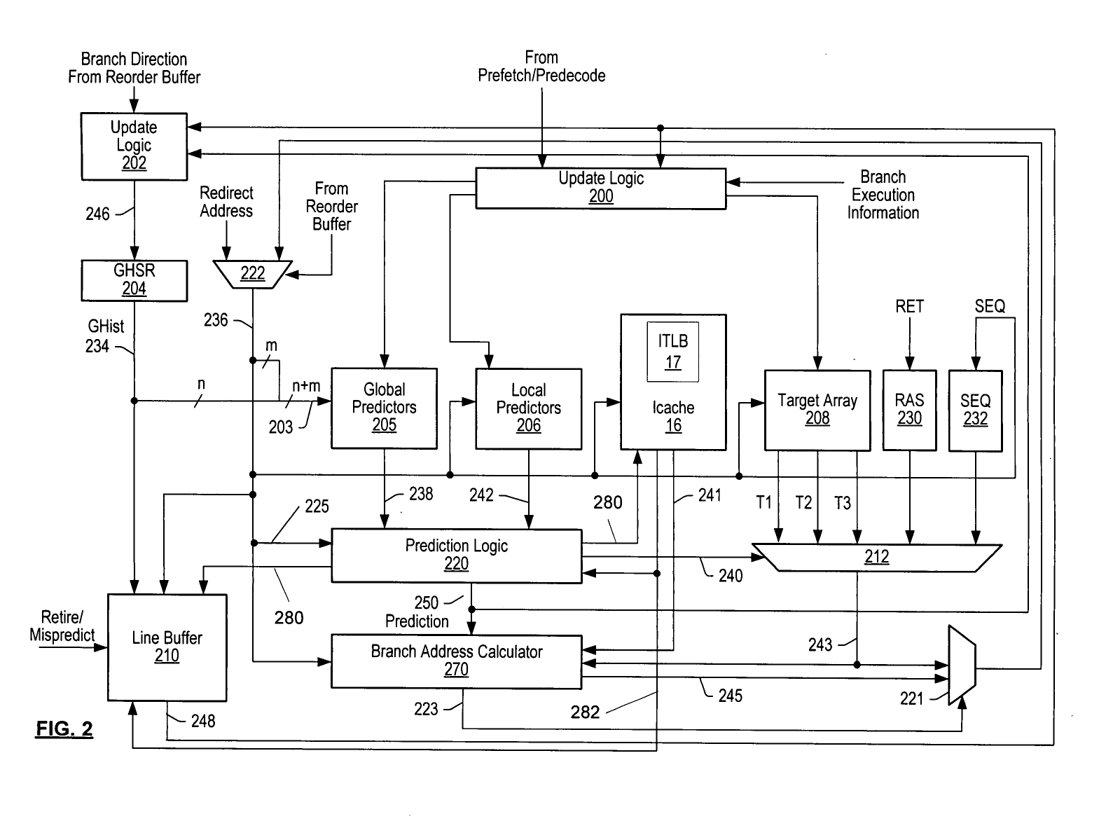

FIG. 2 shows a portion of one embodiment of branch prediction unit 14. Other embodiments of branch prediction unit 14 in addition to the portion shown in FIG. 2 are possible and are contemplated. As shown in FIG. 2, branch prediction unit 14 includes global predictor storage 205, local predictor storage 206, branch target storage 208, update logic 200 and 202, global history shift register 204, line buffer 210, return address stack 230, sequential address generator 232, prediction logic 220 unit, branch address calculator 270, instruction cache 16. Also shown is an instruction translation lookaside buffer (ITLB) 17. ITLB 17 is depicted as being included in Icache 16 for purposes of convenience.

Global predictor storage 205, local predictor storage 206, branch target storage 208, instruction cache 16, prediction logic 220, branch address calculator 270, and line buffer 210 are coupled to a fetch address bus 236 from fetch address multiplexor 222. Global history shift register 204 is coupled to global predictor storage 205 and line buffer 210 via bus 234. Update logic 200 is coupled to global predictor storage 205, local predictor storage 206 and branch target storage 208. Line buffer 210 is coupled to update logic 200 and 202 via bus 248. In addition, update logic 202 is coupled to global history shift register 204 via bus 246. Reorder buffer 32 provides selection control and a redirect address to multiplexor 222. Reorder buffer 32 also provides branch predicted behavior and actual behavior information to update logic 200 and update logic 202. Global predictor storage 205 and local prediction storage 206 are coupled to prediction logic 220 via buses 238 and 242, respectively. Prediction logic 220 is coupled to branch address calculator 270 via bus 250 and multiplexor 212 via select signal 240. Instruction cache 16 is coupled to branch address calculator 270 via bus 241. Multiplexor output 212 is coupled to branch address calculator 270 and multiplexor 221 via bus 243. And branch address calculator 270 is coupled to multiplexor 221 via bus 245, and multiplexor 221 via select signal 223. Finally, the output from multiplexor 221 is coupled to multiplexor 222.

In general, the basic operation of the portion of branch prediction unit 14 shown in FIG. 2 is as follows. A fetch address 236 is conveyed to line buffer 210, local predictor storage 206, target array storage 208 and branch address calculator 270. In addition, a portion of the fetch address 236 is combined with global history 234 to form an index into global predictor storage 205. Further, a portion 225 of fetch address 236 is conveyed to prediction logic 220. Global predictor storage 205 conveys a global prediction 238, local predictor storage 206 conveys a local prediction 242 and target array 208 conveys a target address corresponding to the received fetch address. The local prediction 242 conveyed by local predictor storage 206 provides information to prediction logic 220 for use in forming a branch prediction. Likewise, global predictor storage 205 conveys a global prediction 238 to prediction logic 220 for use in forming the branch prediction. In one embodiment, global prediction 238 may override a local prediction 242 provided by local predictor storage 206 for branches which have exhibited dynamic behavior as discussed below. Finally, prediction logic 220 conveys a signal to multiplexor 212 which selects a next fetch address 243 for use in fetching new instructions. In certain instances, the fetch address 243 conveyed by multiplexor 212 will be the only fetch address conveyed for the current branch prediction. However, in other cases, branch address calculator 270 may convey a second fetch address 245 corresponding to the current branch prediction in response to determining the fetch address 243 conveyed by multiplexor 212 was incorrect. In such a case, branch address calculator 270 may convey a signal 223 for selecting fetch address 245 for output from multiplexor 221. In this manner, a misprediction may be determined and corrected at an early stage.

As mentioned above, in one embodiment a global prediction mechanism may be included in branch prediction unit 14. As previously indicated, prefetch unit 12 may be configured to detect branch instructions and to convey branch information corresponding to a branch instruction to branch prediction unit 14. When a conditional branch is detected, update logic 200 may create a corresponding branch prediction entry in local predictor storage 206 and initialize the newly created branch prediction entry to not taken. In one embodiment, local predictor storage 206 may store branch prediction information, including branch markers, for use in making a branch prediction and choosing from among a plurality of branch target addresses stored in branch target storage 208, a sequential address 232, or return stack address 230. Upon creating an entry in local predictor storage 206 for a branch, the predicted direction of the branch is initialized to not taken and the corresponding branch marker is initialized to indicate a sequential address 232. In addition, an entry corresponding to a conditional branch is created in line buffer 210. A line buffer entry may comprise a global history, fetch address, global prediction and global bit.

When a branch has a not taken prediction in local predictor storage 206, a sequential address 232 is conveyed from multiplexor 212. Final prediction 250 is conveyed to update logic 202 which shifts the predicted direction of branches classified as dynamic into global history shift register 204. When a local branch prediction entry indicates a branch is predicted not taken, final prediction 250 indicates the branch is not taken and signal 240 selects sequential address 232 from multiplexor 212 as the next fetch address. On subsequent executions of the branch, prior to the branch prediction entry being deleted from branch prediction unit 14, the predicted direction for the branch is not taken and the sequential address 232 is conveyed as the next fetch address. Upon retirement, the corresponding entry in line buffer 210 is conveyed to update logic 200 and update logic 202 and deleted from line buffer 210. When a line buffer entry indicates a branch is classified as non-dynamic and reorder buffer 32 indicates the branch was correctly predicted, no update by update logic 200 or 202 is performed. However, if the branch was classified as non-dynamic and was mispredicted, the branch prediction corresponding to the mispredicted branch is updated and the global history shift register 204 is updated as discussed below.

In addition to conveying prediction 250, prediction logic unit 220 is further coupled to convey a way prediction 280 to both Icache 16 and Line Buffer 210. Generally speaking, way prediction 280 provides a predicted way corresponding to the current fetch address 236. Icache 16 is also coupled to convey a way mispredict indication via bus 282 to prediction logic 220 and line buffer 210. Way mispredict bus 282 may also serve to convey corrected way prediction information as discussed further below.

Upon retirement or mispredict, reorder buffer 32 conveys information regarding the behavior of a branch to update logic 200. Also, line buffer 210 conveys a line buffer entry to update logic 200 and 202. When a line buffer branch entry indicates a branch is classified as non-dynamic and predicted not taken, and reorder buffer 32 indicates the corresponding branch was mispredicted, update logic 200 updates the branch prediction entry corresponding to the mispredicted branch. Update logic 200 updates the branch prediction in local predictor storage 206 from not taken to taken and enters the branch target address in branch target storage 208. A “dynamic” (or “global”) bit associated with the stored branch target address is initialized to indicate the branch is classified as static, or non-dynamic, which may be represented by a binary zero. On subsequent executions of the branch, and prior to the branch prediction entry being deleted from branch prediction unit 14, the branch prediction entry indicates a taken prediction and a classification of non-dynamic. When a branch is predicted taken and classified as non-dynamic, prediction logic 220 selects a target from multiplexor 212. As before, if the branch is correctly predicted no branch prediction update is required by update logic 200 or 202. On the other hand, if a non-dynamic predicted taken branch is not taken, the branch prediction entry and global history shift register 204 are updated.

When a branch which is classified as non-dynamic and predicted taken is mispredicted, update logic 200 updates the dynamic bit corresponding to the mispredicted branch in local predictor storage 206 to indicate the branch is classified as dynamic, or global. In addition, update logic 200 updates the global prediction entry in global prediction storage 204 corresponding to the mispredicted branch to indicate the branch is predicted not taken. Also, update logic 202 updates global history shift register 204 to indicate the branch was not taken. In one embodiment, global history shift register 204 tracks the behavior of the last 8 dynamic branches.

When a dynamic branch is fetched, fetch address 236 is conveyed to local predictor storage 206, target array 208 and line buffer 210. In addition, the fetch address is combined with the contents of global history shift register 204 to form an index 203 which is conveyed to global predictor storage 205. The contents of global history shift register 204 are also conveyed to line buffer 210 via bus 234. In one embodiment, index 203 is formed by concatenating bits 9 through 4 of the fetch address 236 with the contents of global history shift register 204. Other methods of forming an index, such as ORing or XORing, are contemplated as well. The index selects an entry in global predictor storage 205 which is conveyed to line buffer 210, update logic 202 and multiplexor 220. The predicted direction of the branch conveyed by global predictor storage 204 is shifted into the global history shift register 204 by update logic 202. For example, a binary one may represent a taken branch and a binary zero may represent a not taken branch. If the corresponding dynamic bit indicates the branch is classified as global and the global prediction indicates the branch is taken, the target address conveyed from multiplexor 212 is selected as the next fetch address. If the global prediction indicates the branch is not taken, the sequential address 232 is selected from multiplexor 212 as the next fetch address.

Upon retirement, reorder buffer 32 conveys branch information to update logic 200 and update logic 202. In addition, line buffer 210 conveys the corresponding branch information to update logic 202. When reorder buffer 32 indicates a dynamic branch is correctly predicted, update logic 200 modifies global prediction entry 205 to indicate the behavior of the branch. In one embodiment, global branch prediction entries comprise a saturating counter. Such a counter may be two bits which are incremented on taken branches and decremented on not taken branches. Such an indicator may be used to indicate a branch is strongly taken, weakly taken, strongly not taken, or weakly not taken. If a dynamic branch is mispredicted, update logic 200 updates the global prediction entry 205 to indicate the branch behavior. In addition, upon misprediction update logic 202 repairs global history shift register 204 to reflect the actual, rather than the predicted, behavior of the dynamic branch.

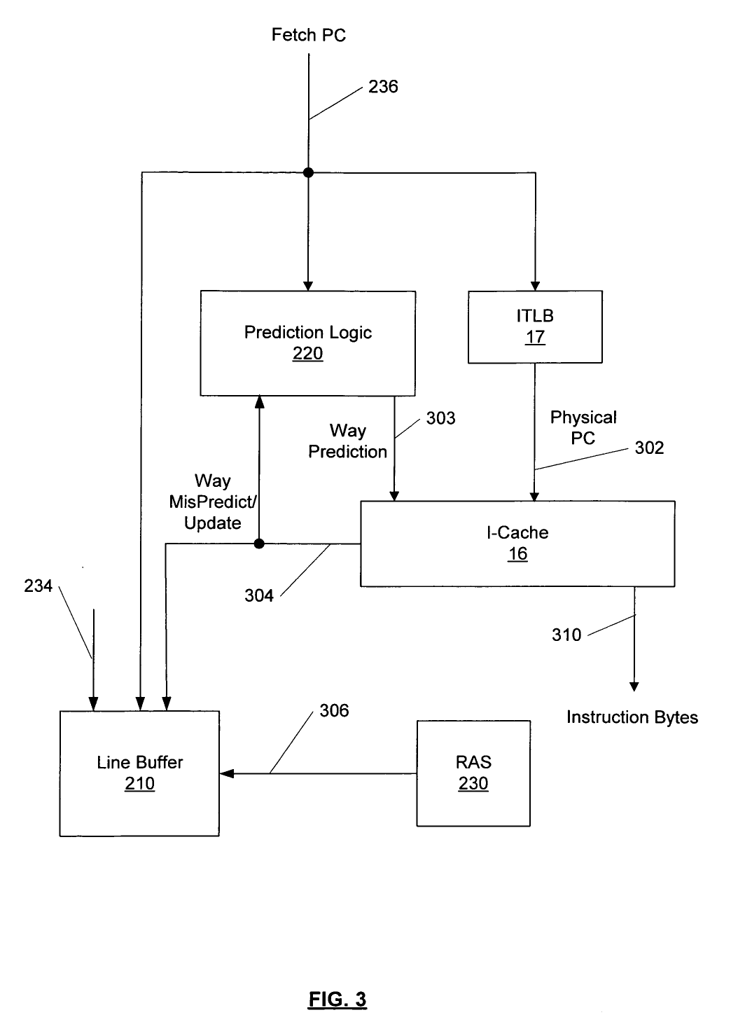

Turning now to FIG. 3, a block diagram illustrating one embodiment of a portion of the branch prediction unit 14 is shown. In the embodiment shown, prediction logic 220, ITLB 17, and line buffer 210, are each coupled to receive a fetch address 236. Line buffer 210 is further coupled to receive data from global history shift register 204 via bus 234. ITLB 17 is configured to convey an address 302 to Icache 16. Prediction logic 220 is coupled to convey a way prediction to Icache 16 via bus 303. Icache 16 is configured to convey instruction bytes via bus 310. In addition, Icache 16 is configured to convey a way mispredict/update indication via bus 304. Also shown is return address stack (RAS) 30 which is configured to convey data to line buffer 210. RAS 230 is also coupled (not shown) to convey return address information as is ordinarily understood in the art.

Generally speaking, a fetch address (fetch PC) for instructions is provided via bus 236. Prediction logic 220 is generally configured to provide a branch prediction, and is also configured to provide a way prediction to the Icache 16 for the currently presented fetch address. In various embodiments, way prediction information may be stored within prediction logic 220, or may be received from predictor storage (205 or 206). In parallel with prediction logic 220, ITLB 17 translates the fetch address (which is a virtual address in the present embodiment) to a physical address (physical PC) for access to I-cache 16. I-cache 16 reads instruction bytes corresponding to the physical address and provides the instruction bytes via bus 310. In one embodiment, in the event of a branch instruction, an entry corresponding to the branch is created in line buffer 210. A line buffer entry may comprise a global history, fetch address, global prediction and global bit. In addition, the entry may include the branch instruction index, the branch instruction way, and the predicted way for the following instruction. Further, in one embodiment, in addition to storing a return address on return address stack 230, return address stack 230 may also be configured to store information corresponding to the source (calling) branch instruction. Such information may include the source instruction index, source instruction way, and the source instruction's predicted way (i.e., the way predicted for the next instruction by the source instruction).

In response to receiving the fetch address and predicted way, I-cache 16 may read the predicted way identified by the way prediction and provide the read instruction bytes via bus 310. Advantageously, the latency for accessing I-cache 16 may be reduced since the tag comparisons are not used to select output data. Further, power consumption may be reduced by idling the non-predicted ways (i.e. not accessing the non-predicted ways), and thus the power that would be consumed by accessing the non-predicted ways is conserved. If the fetch address misses the predicted way, I-cache 16 may search the non-predicted ways.

If a way prediction miss is detected, I-cache 16 may assert a mispredict signal 304 which temporarily pauses further generation of fetch addresses to allow I-cache 16 to search for a hit in the non-predicted ways. Once a hit is detected, I-cache 16 may provide an updated way prediction to prediction logic 220 and line buffer 210. Prediction logic 220 may update the corresponding entry with the updated way prediction. Similarly, line buffer 210 may update the corresponding entry with the updated way prediction. If a miss is detected (i.e. none of the ways have a matching tag), then I-cache 16 may select a replacement way and provide the replacement way as an updated way prediction.

As discussed above, in certain situations there may be a significant number of instructions executed between the time a branch instruction is executed and the time a corresponding subroutine completes and returns. For example, a fetched cache line may include a CALL, or similar type, instruction. Associated with the fetched CALL instruction is a way prediction for the following sequential instruction which is used by the corresponding RET instruction. The CALL may then branch to a subroutine which includes hundreds or thousands of instructions. The RET instruction is subsequently encountered and the return address is popped from the return address stack. The previously stored way prediction is also popped from the return stack. A fetch is then performed using the return address and the way which was predicted much earlier by the corresponding CALL. As the CALL data which includes the predicted way information may be long since lost, there may not generally be any to repair the way prediction information in the event the way mispredicts. Therefore, in order to address this problem, RAS 230 is configured to include information which corresponds to the CALL instruction. In particular, the entry for a given return address may also include fields which store the CALL instruction index, the CALL instruction way, and the way predicted by the CALL. Subsequently, when the corresponding RET is encountered and the subroutine returns, the return address is popped from the RAS 230, as well as the previously stored information which corresponds to the CALL instruction. Therefore, if the predicted way misses, the calling branch instruction which is associated with the way prediction can be identified and the way prediction repaired. In this manner, the way prediction may be repaired just as in the sequential fetch mode scenario.

In various embodiments, way prediction data may be updated immediately upon detection, or the way prediction information may be updated upon retirement of the corresponding line from the line buffer 210. In the latter case, updates are made to the way prediction information within an entry of the line buffer 210, and the final update is made when the corresponding line is retired.

As used herein, an “address” is a value which identifies a byte within a memory system to which processor 10 may be coupled. A “fetch address” is an address used to fetch instruction bytes to be executed as instructions within processor 10. As mentioned above, processor 10 may employ an address translation mechanism in which virtual addresses (generated in response to the operands of instructions) are translated to physical addresses (which physically identify locations in the memory system). In the x86 instruction set architecture, virtual addresses may be linear addresses generated according to a segmentation mechanism operating upon logical addresses generated from operands of the instructions. Other instruction set architectures may define the virtual address differently.

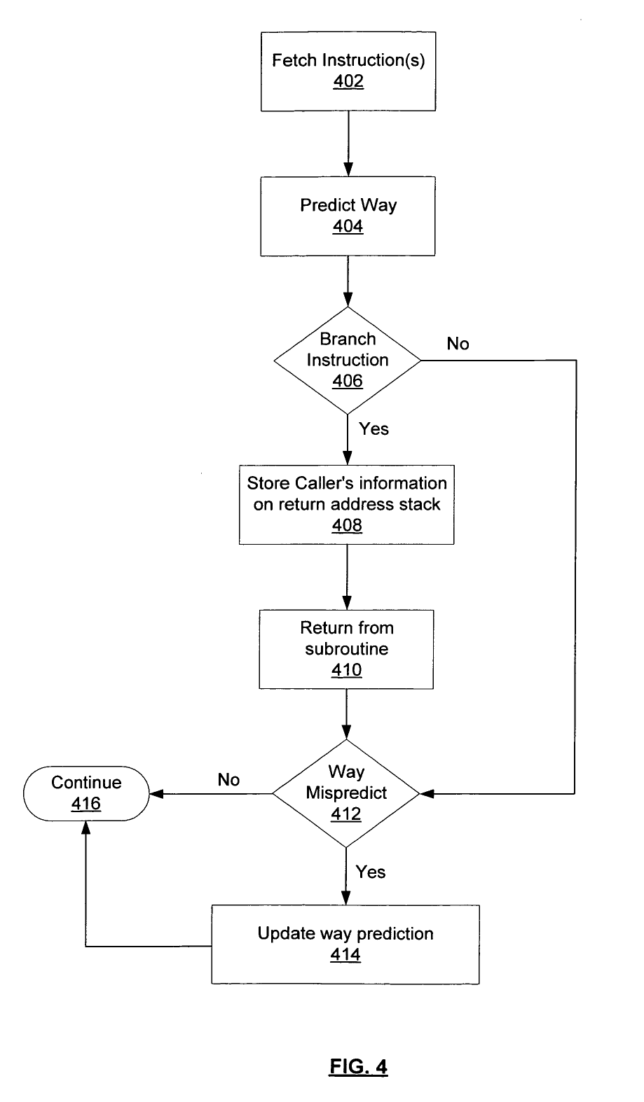

Turning now to FIG. 4, one embodiment of a method for updating way mispredictions is shown. In the embodiment shown, a line is fetched 402 and a way for the next fetch is predicted 404. If the current fetch includes a CALL instruction (decision block 406), the corresponding return address is pushed on the return address stack. In addition, to storing the return address on the return address stack, a predicted way for the return address is stored, and identifying information related to the CALL instruction is stored. In one embodiment, the identifying information may include an index and way of the CALL instruction. However, other embodiments may store additional, or alternative, identifying information as deemed appropriate. Subsequently, a RET instruction is encountered (block 410), and an access to the is Icache performed using the popped return address and predicted way. If the way mispredicts (decision block 412), the identifying information popped from the return stack used to identify the corresponding CALL instruction and update the way prediction information (block 414). If the way is not mispredicted (decision block 412), then processing may simply continue (416). If at decision block 406, a branch instruction is not encountered, then ordinary sequential type processing may occur in which a way mispredict may be detected (decision block 412) and updated (block 414).

Computer Systems

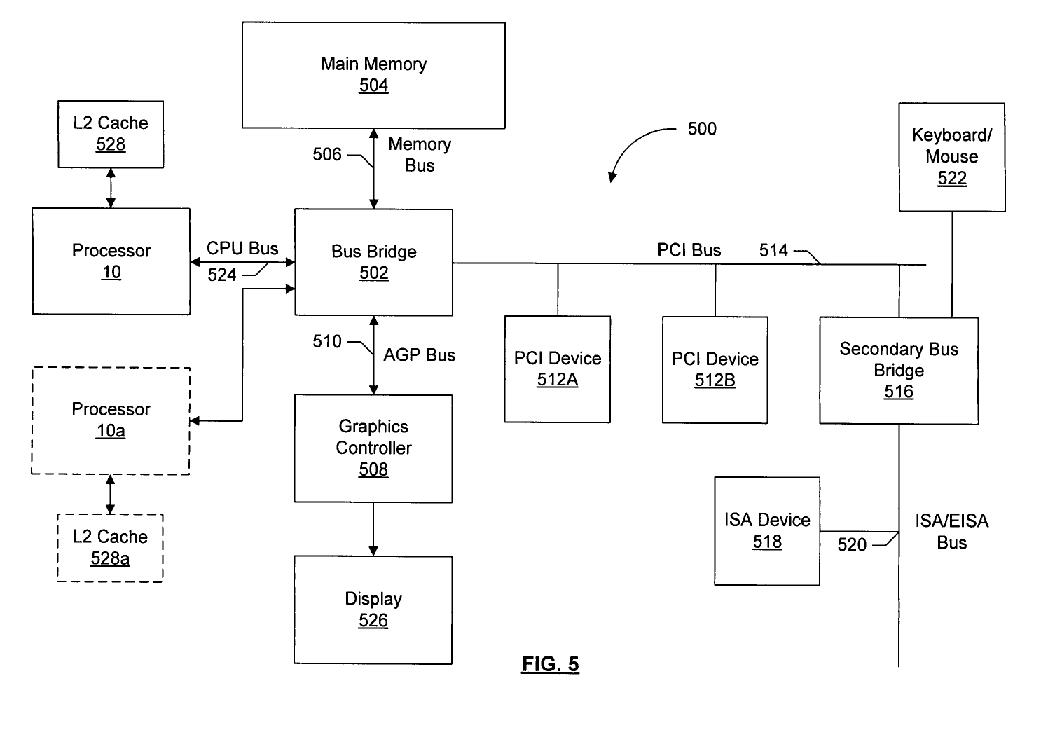

Turning now to FIG. 5, a block diagram of one embodiment of a computer system 500 including processor 10 coupled to a variety of system components through a bus bridge 502 is shown. Other embodiments are possible and contemplated. In the depicted system, a main memory 504 is coupled to bus bridge 502 through a memory bus 506, and a graphics controller 508 is coupled to bus bridge 502 through an AGP bus 510. Finally, a plurality of PCI devices 512A-512B are coupled to bus bridge 502 through a PCI bus 514. A secondary bus bridge 516 may further be provided to accommodate an electrical interface to one or more EISA or ISA devices 518 through an EISA/ISA bus 520. Processor 10 is coupled to bus bridge 502 through a CPU bus 524 and to an optional L2 cache 528.

Bus bridge 502 provides an interface between processor 10, main memory 504, graphics controller 508, and devices attached to PCI bus 514. When an operation is received from one of the devices connected to bus bridge 502, bus bridge 502 identifies the target of the operation (e.g. a particular device or, in the case of PCI bus 514, that the target is on PCI bus 514). Bus bridge 502 routes the operation to the targeted device. Bus bridge 502 generally translates an operation from the protocol used by the source device or bus to the protocol used by the target device or bus.

In addition to providing an interface to an ISA/EISA bus for PCI bus 514, secondary bus bridge 516 may further incorporate additional functionality, as desired. An input/output controller (not shown), either external from or integrated with secondary bus bridge 516, may also be included within computer system 500 to provide operational support for a keyboard and mouse 522 and for various serial and parallel ports, as desired. An external cache unit (not shown) may further be coupled to CPU bus 524 between processor 10 and bus bridge 502 in other embodiments. Alternatively, the external cache may be coupled to bus bridge 502 and cache control logic for the external cache may be integrated into bus bridge 502. L2 cache 528 is further shown in a backside configuration to processor 10. It is noted that L2 cache 528 may be separate from processor 10, integrated into a cartridge (e.g. slot 1 or slot A) with processor 10, or even integrated onto a semiconductor substrate with processor 10.

Main memory 504 is a memory in which application programs are stored and from which processor 10 primarily executes. A suitable main memory 504 comprises DRAM (Dynamic Random Access Memory). For example, a plurality of banks of SDRAM (Synchronous DRAM) or Rambus DRAM (RDRAM) may be suitable.

PCI devices 512A-512B are illustrative of a variety of peripheral devices such as, for example, network interface cards, video accelerators, audio cards, hard or floppy disk drives or drive controllers, SCSI (Small Computer Systems Interface) adapters and telephony cards. Similarly, ISA device 518 is illustrative of various types of peripheral devices, such as a modem, a sound card, and a variety of data acquisition cards such as GPIB or field bus interface cards.

Graphics controller 508 is provided to control the rendering of text and images on a display 526. Graphics controller 508 may embody a typical graphics accelerator generally known in the art to render three-dimensional data structures which can be effectively shifted into and from main memory 504. Graphics controller 508 may therefore be a master of AGP bus 510 in that it can request and receive access to a target interface within bus bridge 502 to thereby obtain access to main memory 504. A dedicated graphics bus accommodates rapid retrieval of data from main memory 504. For certain operations, graphics controller 508 may further be configured to generate PCI protocol transactions on AGP bus 510. The AGP interface of bus bridge 502 may thus include functionality to support both AGP protocol transactions as well as PCI protocol target and initiator transactions. Display 526 is any electronic display upon which an image or text can be presented. A suitable display 526 includes a cathode ray tube (“CRT”), a liquid crystal display (“LCD”), etc.

It is noted that, while the AGP, PCI, and ISA or EISA buses have been used as examples in the above description, any bus architectures may be substituted as desired. It is further noted that computer system 500 may be a multiprocessing computer system including additional processors (e.g. processor 10a shown as an optional component of computer system 500). Processor 10a may be similar to processor 10. More particularly, processor 10a may be an identical copy of processor 10. Processor 10a may be connected to bus bridge 502 via an independent bus (as shown in FIG. 10) or may share CPU bus 524 with processor 10. Furthermore, processor 10a may be coupled to an optional L2 cache 528a similar to L2 cache 528.

Numerous variations and modifications will become apparent to those skilled in the art once the above disclosure is fully appreciated. It is intended that the following claims be interpreted to embrace all such variations and modifications.

What is claimed is:

1. A processor comprising:
an instruction cache coupled to receive a fetch address and a corresponding way prediction, wherein said instruction cache comprises a plurality of ways and is configured to convey a way mispredict indication responsive to detecting a way misprediction; and
a return address stack configured to store:
a return address corresponding to a fetched branch instruction;
a return address way prediction; and
information identifying the branch instruction;
wherein in response to detecting the return address way prediction is incorrect, the information identifying the branch instruction is utilized to repair the return address way prediction.

2. The processor as recited in claim 1, further comprising a prediction logic unit configured to provide the way prediction which corresponds to the fetch address.

3. The processor as recited in claim 2, wherein if said instruction cache determines that a fetch address misses in a corresponding predicted way, said instruction cache is configured to search for a hit in additional ways.

4. The processor as recited in claim 3, wherein said instruction cache is further configured to assert a miss signal in response to detecting a cache fetch miss.

5. The processor as recited in claim 3, wherein in response to detecting a hit in said additional ways, said instruction cache is configured to provide an updated way prediction to said prediction logic unit.

6. The processor as recited in claim 1, wherein the information identifying the branch instruction comprises an index and way corresponding to the branch instruction.

7. The processor as recited in claim 6, wherein the branch instruction comprises a subroutine call.

8. A computer system comprising:
a processor including:
an instruction cache coupled to receive a fetch address and a corresponding way prediction, wherein said instruction cache comprises a plurality of ways and is configured to convey a way mispredict indication responsive to detecting a way misprediction; and
a return address stack configured to store:
a return address corresponding to a branch instruction;
a return address way prediction; and
information identifying the branch instruction;
wherein in response to detecting the return address way prediction is incorrect, the information identifying the branch instruction is utilized to repair the return address way prediction;
an input/output (I/O) device configured to communicate between said computer system and another computer system to which said I/O device is couplable.

9. The computer system as recited in claim 8, further comprising a prediction logic unit configured to provide the way prediction which corresponds to the fetch address.

10. The computer system as recited in claim 9, wherein if said instruction cache determines that a fetch address misses in a corresponding predicted way, said instruction cache is configured to search for a hit in additional ways.

11. The computer system as recited in claim 10, wherein said instruction cache is further configured to assert a miss signal in response to detecting a cache fetch miss.

12. The computer system as recited in claim 10, wherein in response to detecting a hit in said additional ways, said instruction cache is configured to provide an updated way prediction to said prediction logic unit.

13. The computer system as recited in claim 8, wherein said I/O device comprises a modem.

14. The computer system as recited in claim 13, further comprising an audio I/O device.

15. The computer system as recited in claim 8, further comprising a second processor identical to said processor.

16. A method comprising:
receiving in an instruction cache a fetch address and corresponding way prediction, wherein said instruction cache comprises a plurality of ways and is configured to convey a way mispredict indication responsive to detecting a way misprediction;
identifying a return address way prediction corresponding to a branch instruction;
pushing on a return address stack:
a return address corresponding to the branch instruction;
the return address way prediction; and
information identifying the branch instruction;
utilizing the information identifying the branch instruction to repair the return address way prediction, in response to detecting the return address way prediction is incorrect.

17. The method as recited in claim 16, further comprising a prediction logic unit providing a fetch address and corresponding way prediction to the instruction cache.

18. The method as recited in claim 17, further comprising said instruction cache searching for a hit in additional ways, in response to determining that a fetch address misses in a corresponding predicted way.

19. The method as recited in claim 18, further comprising said instruction cache asserting a miss signal in response to detecting a cache fetch miss.

20. The method as recited in claim 18, further comprising said instruction cache providing an updated way prediction in response to detecting a hit in said additional ways.
